(19) United States
(12) Patent Application Publication
(10) Pub. No.: US 2011/0069763 A1
(43) Pub. Date: Mar. 24, 2011

(54) SCALABLE VIDEO ENCODING/DECODING METHOD AND APPARATUS FOR INCREASING IMAGE QUALITY OF BASE LAYER

(75) Inventors: Il Hong Shin, Daejeon (KR); Jeong Ju Yoo, Daejeon (KR); Jong Soo Lim, Daejeon (KR); Won Ryu, Daejeon (KR)

(73) Assignee: Electronics and Telecommunications Research Institute, Daejeon (KR)

(21) Appl. No.: 12/690,994

(22) Filed: Jan. 21, 2010

(30) Foreign Application Priority Data
Sep. 21, 2009 (KR) 10-2009-0089085

(51) Int. Cl. H04N 7/26

(52) U.S. Cl. 375/240.17; 375/240.29; 375/240.16; 375/E07.078; 375/E07.123

(57) ABSTRACT

Provided are a scalable video encoding/decoding method and apparatus, which may improve an image quality of a base layer while not using an anti-aliasing filter. The scalable video decoding apparatus includes an entropy decoding unit to decode an image received from an encoding apparatus, a de-blocking filter to reduce a block distortion of the decoded image, a motion compensation unit to apply a motion compensation scheme to an image passing through the de-blocking filter, a half-pel filter to apply a half-pel compensation scheme to an image where the motion compensation scheme is applied by the motion compensation unit, and an output unit to output an image where the half-pel compensation scheme is applied by the half-pel filter.

### CROSS-REFERENCE TO RELATED APPLICATION

This application claims the benefit of Korean Patent Application No. 10-2009-0089085, filed on Sep. 21, 2009, in the Korean Intellectual Property Office, the disclosure of which is incorporated herein by reference.

### BACKGROUND

1. Field of the Invention

Embodiments of the present invention relate to a scalable video encoding/decoding method and application, and more particularly, a scalable video encoding/decoding method and application, which may improve an image quality of a base layer while not using an anti-aliasing filter.

2. Description of the Related Art

A relay node in a mobile communication system may be installed in a shadow region that is difficult to be covered by a base station, and may be used to expand a service region while supporting high-speed data transmission and to support group mobility.

However, a conventional relay node may only have a function to relay transmission/reception information between a base station and a terminal and thus, a private network such as a wireless Local Area Network (LAN) may be used in a relatively small area to provide specialized services to a corresponding region.

A Scalable Video Codec (SVC) scheme may encode image signals to have a most excellent image quality, and decode only a partial sequence, that is, a sequence of a frame intermittently selected from an entire sequence in accordance with the encoded image signals, thereby expressing images with relatively low-image quality.

In the SVC scheme, encoding efficiency may rely on a down-sampling method that may change a spatial correlation.

The down-sampling method may apply an anti-aliasing filter to an original image to prevent any occurrence of aliasing in a frequency domain, and may decimate pixels in accordance with a ratio of the down-sampling, when a filtering using the anti-aliasing filter is completed.

To maximally increase a spatial correlation in a scalable video encoder having two spatial resolutions, the anti-aliasing filter may not be used.

In this case, information distortion occurring due to an encoding performed by the scalable video encoder may be minimal, and thereby the highest encoding efficiency may be shown while encoding a spatial scalable video.

However, when the anti-aliasing is not used, the aliasing may significantly occur, causing a reduction in an image quality of a base layer.

Accordingly, there is a desire for a method and apparatus of preventing an occurrence of the aliasing while not using the anti-aliasing filter.

### SUMMARY

An aspect of the present invention provides a scalable video decoding apparatus, which may process an image, which is de-blocked using a de-blocking filter, utilizing a motion compensation scheme, a half-pel filter, and a quarter-pel filter in the stated order to thereby output the processed image, without directly outputting the de-blocked image, whereby an image quality of a base layer may be improved without an increase in an amount of computation and without using an anti-aliasing filter.

An aspect of the present invention also provides a scalable video encoding/decoding apparatus, in which, when the scalable video encoding apparatus computes an optimal filter coefficient based on an encoded image and a reference image and transmits the computed optimal filter coefficient together with the encoded image to the scalable video decoding apparatus, the scalable video decoding apparatus may eliminate aliasing using the received optimal filter coefficient, whereby an image quality of a base layer may be improved without using the anti-aliasing filter.

According to an aspect of the present invention, there is provided a scalable video decoding apparatus, including: an entropy decoding unit to decode an image received from an encoding apparatus; a de-blocking filter to reduce a block distortion of the decoded image; a motion compensation unit to apply a motion compensation scheme to an image passing through the de-blocking filter; a half-pel filter to apply a half-pel compensation scheme to an image where the motion compensation scheme is applied by the motion compensation unit; and an output unit to output an image where the half-pel compensation scheme is applied by the half-pel filter.

According to another aspect of the present invention, there is provided a scalable video encoding apparatus, including: an encoding unit to encode an image inputted by a user; an anti-aliasing filter computation unit to compute an optimal filter coefficient based on the image encoded in the encoding unit and a reference image; and an output unit to store and transmit the encoded image and the optimal filter coefficient.

According to still another aspect of the present invention, there is provided a scalable video decoding apparatus, including: an input unit to receive, from an encoding apparatus, an encoded image and an optimal filter coefficient; an entropy decoding unit to decode the encoded image; a de-blocking filter to reduce a block distortion of the decoded image; a motion compensation unit to apply a motion compensation scheme to an image passing through the de-blocking filter; and an aliasing elimination unit to eliminate an aliasing from the image passing through the de-blocking filter using the optimal filter coefficient, and to output an image where the aliasing is eliminated.

According to still another aspect of the present invention, there is provided a down-sampling method for decoding a scalable video, the down-sampling method including: decoding an image received from an encoding apparatus; reducing a block distortion by de-blocking the decoded image; applying a motion compensation scheme to the de-blocked image; applying a half-pel compensation scheme to an image where the motion compensation scheme is applied; and outputting an image where the half-pel compensation scheme is applied.

According to yet another aspect of the present invention, there is provided a scalable video encoding method, including: encoding an inputted image; computing an optimal filter coefficient based on the encoded image and a reference image; and storing and transmitting the encoded image and the optimal filter coefficient.

According to further aspect of the present invention, there is provided a down-sampling method for decoding a scalable video, the down-sampling method including: receiving, from an encoding apparatus, an encoded image and an optimal filter coefficient; decoding the encoded image; reducing a block distortion by de-blocking the decoded image; applying a motion compensation scheme to the de-blocked image; eliminating an aliasing from the de-blocking image using the optimal filter coefficient; and outputting an image where the aliasing is eliminated.

### EFFECT

According to embodiments of the present invention, there may be provided a scalable video decoding apparatus, which may process an image, which is de-blocked using a de-blocking filter, utilizing a motion compensation scheme, a half-pel filter, and a quarter-pel filter in the stated order to thereby output the processed image, without directly outputting the de-blocked image, whereby an image quality of a base layer may be improved without an increase in an amount of computation and without using an anti-aliasing filter.

Also, according to embodiments of the present invention, there may be provided a scalable video encoding/decoding apparatus in which, when the scalable video encoding apparatus computes an optimal filter coefficient based on an encoded image and a reference image and transmits the computed optimal filter coefficient together with the encoded image to the scalable video decoding apparatus, the scalable video decoding apparatus may eliminate aliasing using the received optimal filter coefficient, whereby an image quality of a base layer may be improved without using the anti-aliasing filter.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an example of a scalable video decoding apparatus according to exemplary embodiments;

FIG. 2 is a flowchart illustrating a down-sampling method of decoding a scalable video according to exemplary embodiments;

FIG. 3 illustrates an example of a scalable video encoding apparatus according to exemplary embodiments;

FIG. 4 illustrates an example of a scalable video decoding apparatus according to other exemplary embodiments;

FIG. 5 is a flowchart illustrating a scalable video encoding method according to exemplary embodiments; and

FIG. 6 is a flowchart illustrating a down-sampling method of decoding a scalable video according to other exemplary embodiments.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

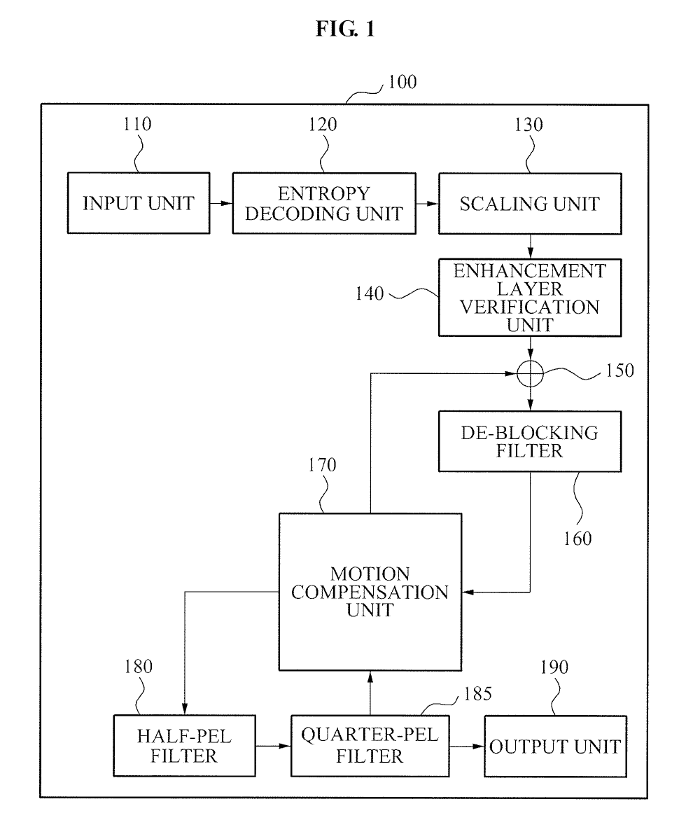

FIG. 1 illustrates an example of a scalable video decoding apparatus 100 according to exemplary embodiments.

The scalable video decoding apparatus 100 includes an input unit 110, an entropy decoding unit 120, a scaling unit 130, an enhancement layer verification unit 140, a combining unit 150, a de-blocking filter 160, a motion compensation unit 170, a half-pel filter 180, a quarter-pel filter 185, and an output unit 190.

The scalable video decoding apparatus 100 may process an image, which is de-blocked using the de-blocking filter 160, sequentially utilizing the motion compensation unit 140, the half-pel filter 180, and the quarter-pel filter 185 to thereby output the processed image, without directly outputting the de-blocked image, whereby an image quality of a base layer may be improved without an increase in an amount of computation and without using an anti-aliasing filter.

The input unit 110 may receive an encoded image from an encoding apparatus. In this instance, the input unit 110 may receive an image encoded in a conventional encoding apparatus.

The entropy decoding unit 120 may decode the image received from the encoding apparatus by the input unit 110.

The scaling unit 130 may scale the image decoded in the entropy decoding unit 120 to convert the image quality.

The enhancement layer verification unit 140 may verify whether an enhancement layer is included in the image converted in the scaling unit 130. In this instance, when the enhancement layer is included in the image, the enhancement layer verification unit 140 may estimate an inter-layer, otherwise, the enhancement layer verification unit 140 may not perform a supplementary operation.

The combining unit 150 may add, to an image outputted from the enhancement layer verification unit 140, an image where a motion compensation scheme is applied, and transmit the added images to the de-blocking filter 160.

The de-blocking filter 160 may apply a de-blocking filtering to the image outputted from the enhancement layer verification unit 140 to thereby reduce block distortion. Also, the de-blocking filter 160 may apply the de-blocking scheme to the image where the motion compensation scheme is applied by the motion compensation unit 170, based on the inter-layer estimated in the enhancement layer verification unit 140.

The motion compensation unit 170 may apply the motion compensation scheme to an image passing through the de-blocking filter 160.

The half-pel filter 180 may apply a half-pel compensation scheme to the image where the motion compensation scheme is applied by the motion compensation unit 170 to thereby generate a half-pel filtering image.

The quarter-pel filter 185 may apply a quarter-pel compensation to an image where the half-pel compensation scheme is applied by the half-pel filter 180 to thereby generate a quarter-pel filtering image.

The output unit 190 may select one of the half-pel filtering image and the quarter-pel filtering image in accordance with an input of a user or a predetermined condition, and output the selected image.

Also, since a size of each of the quarter-pel filtering image and the half-pel filtering image may become larger than that of an original image before being encoded, while the quarter-pel filtering image and the half-pel filtering image are passing through the motion compensation unit 170, the half-pel filter 180, and the quarter-pel filter 185, the output unit 190 may adjust a size of the outputted image by applying a pixel decimation scheme to the selected image.

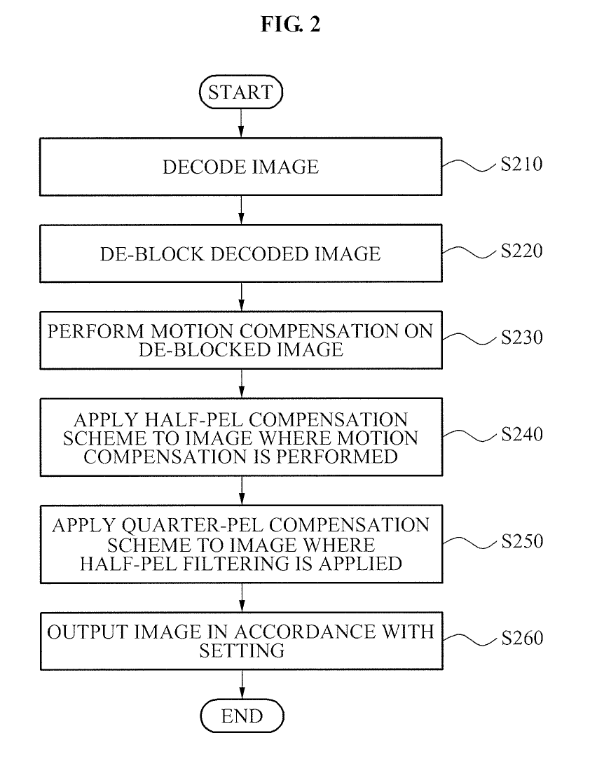

FIG. 2 is a flowchart illustrating a down-sampling method of decoding a scalable video according to exemplary embodiments.

In operation S210, the entropy decoding unit 120 may decode an image received from an encoding apparatus by the input unit 110, and transmit the decoded image to the de-blocking filter 160.

In this instance, the scaling unit 130 may scale the image decoded in the entropy decoding unit 120 to transmit the scaled image to the de-blocking filter 160, and the enhancement layer verification unit 140 may estimate the inter-layer when the enhancement layer is included in the image scaled in the scaling unit 130, and transmit the estimated inter-layer to the de-blocking filter 160.

Also, the combining unit 150 may add the image, where the motion compensation scheme is applied in the motion compensation unit 170, to the image outputted in the entropy decoding unit 120, the scaling unit 130, or the enhancement layer verification unit 140, and transmit the added images to the de-blocking filter 160.

In operation S220, the de-blocking filter 160 may apply the de-blocking filtering to the decoded image to thereby reduce block distortion.

In this instance, the de-blocking filter 160 may apply the de-blocking filtering to the image where the motion compensation scheme is applied in the motion compensation unit 170, based on the inter-layer estimated in the enhancement layer verification unit 140, thereby reducing the block distortion.

In operation S230, the motion compensation unit 170 may apply the motion compensation scheme to the image de-blocked in operation S230.

In operation S240, the half-pel filter 180 may apply a half-pel compensation scheme to the image where the motion compensation scheme is applied in operation S230, thereby generating a half-pel filtering image.

In operation S250, the quarter-pel filter 185 may apply a quarter-pel compensation scheme to the image where the half-pel compensation scheme is applied, thereby generating a quarter-pel filtering image.

In operation S260, the output unit 190 may select one of the quarter-pel filtering image generated in operation 250 and the half-pel filtering image generated in operation S240 in accordance with an input of a user and a predetermined condition, and output the selected image.

In this instance, the output unit 190 may adjust a size of the outputted image by applying a pixel decimation to the selected image.

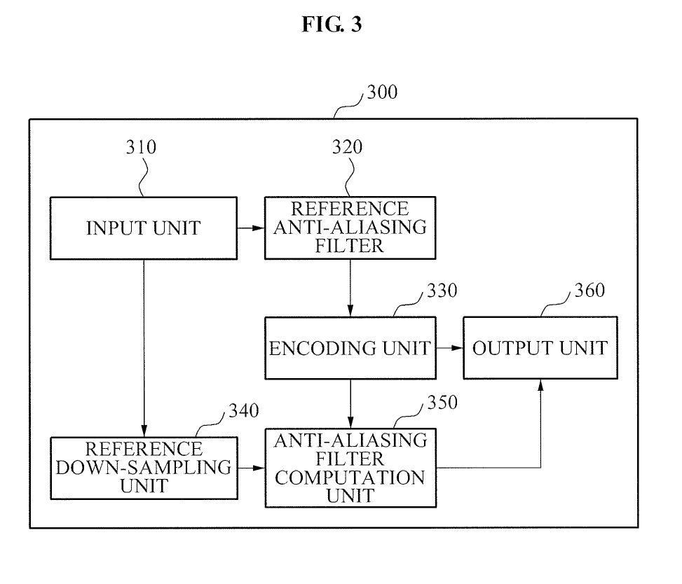

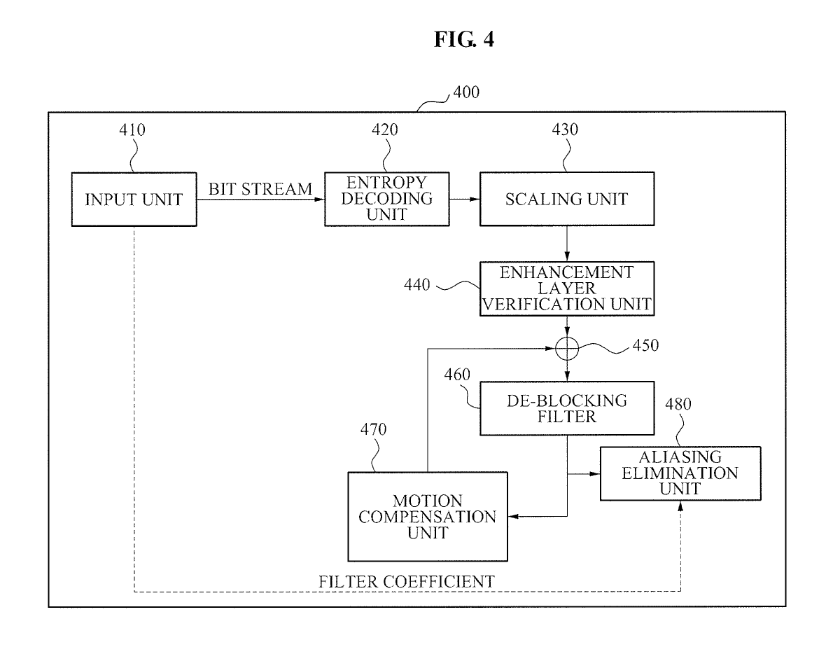

FIG. 3 illustrates an example of a scalable video encoding apparatus 300 according to exemplary embodiments, and FIG. 4 illustrates an example of a scalable video decoding apparatus 400 according to other exemplary embodiments.

As for the scalable video encoding apparatus 300 and the scalable video decoding apparatus 400, when the scalable video encoding apparatus 300 computes an optimal filter coefficient based on an encoded image and a reference image to thereby transmit the computed filter coefficient together with the encoded image to the scalable video decoding apparatus 400, the scalable video decoding apparatus 400 may eliminate aliasing using the received optimal filter coefficient, thereby improving an image quality of a base layer without using an anti-aliasing filter.

The scalable video encoding apparatus 300 includes, as illustrated in FIG. 3, an input unit 310, a reference anti-aliasing filter 320, an encoding unit 330, a reference down-sampling unit 340, an anti-aliasing filter computation unit 350, and an output unit 360.

The input unit 310 may receive an image intended to be encoded from a user.

The reference anti-aliasing filter 320 may apply a reference anti-aliasing filtering to an image inputted in the input unit 310 to thereby generate an image where the reference anti-aliasing filtering is applied.

The encoding unit 330 may encode the image inputted by the user or the image where the reference anti-aliasing filtering is applied.

In this instance, when the image is inputted in the encoding unit 330, the image to be encoded by the encoding unit 330 may be an image where anti-aliasing is not considered, or an image where a down-sampling is applied to reduce the anti-aliasing.

The reference down-sampling unit 340 may apply down-sampling to the reference image.

The anti-aliasing filter computation unit 340 may compute an optimal filter coefficient based on the image encoded by the encoding unit 330 and the reference image. In this instance, the reference image may be an image where the down-sampling is applied by the reference down-sampling unit 340.

Specifically, the anti-aliasing filter computation unit 350 may apply a two-dimensional filter or a one-dimensional filter to the encoded image and the reference image to compute the optimal filter coefficient.

The output unit 360 may store the optimal filter coefficient computed by the anti-aliasing filter computation unit 350 and the image encoded by the encoding unit 330, and transmit the stored encoded image and optimal filter coefficient to the scalable video decoding unit 400.

Also, the scalable video decoding apparatus 400 includes, as illustrated in FIG. 4, an input unit 410, an entropy decoding unit 420, a scaling unit 430, an enhancement layer verification unit 440, a combining unit 450, a de-blocking filter 460, a motion compensation unit 470, and an aliasing elimination unit 480.

In this instance, the input unit 410, the entropy decoding unit 420, the scaling unit 430, the enhancement layer verification unit 440, the combining unit 450, the de-blocking filter 460, the motion compensation unit 470, and the aliasing elimination unit 480 may have the same configurations as those of the entropy decoding unit 120, the scaling unit 130, the enhancement layer verification unit 140, the combining unit 150, the de-blocking filter 160, and the motion compensation unit 170 of the scalable video decoding apparatus 100, and thus detailed descriptions thereof will be herein omitted.

The input unit 410 may receive an encoded image and an optimal filter coefficient from the scalable video encoding apparatus 300, and transmit the encoded image to the entropy decoding unit 420 and the optimal filter coefficient to the aliasing elimination unit 480, respectively.

The aliasing elimination unit 480 may eliminate aliasing from an image where a de-blocking scheme is applied using the optimal filter coefficient, and output an image where the aliasing is eliminated.

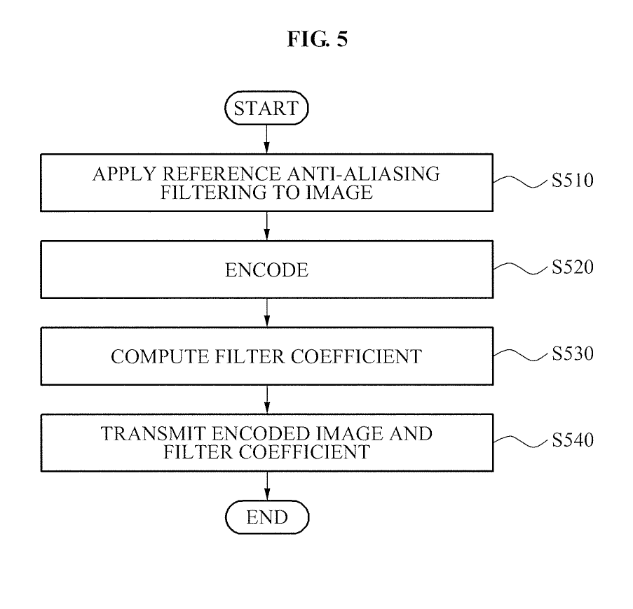

FIG. 5 is a flowchart illustrating a scalable video encoding method according to exemplary embodiments.

In operation S510, the reference anti-aliasing filter 320 may apply a reference anti-aliasing filtering to the image inputted by the input unit 310 to thereby generate an image where the reference anti-aliasing filtering is applied.

In operation S520, the encoding unit 330 may encode the image generated in operation S510. In this instance, an image to be encoded by the encoding unit 330 may be an image where anti-aliasing is not considered, or an image where a down-sampling is applied to reduce the anti-aliasing.

In operation S530, the anti-aliasing filter computation unit 350 may compute an optimal filter coefficient based on the image encoded in operation S520 and a reference image. In this instance, the reference image may be an image where the down-sampling is applied by the down-sampling unit 340.

Specifically, the anti-aliasing filter computation unit 350 may apply a two-dimensional filter or a one-dimensional filter to the encoded image and the reference image to compute the optimal filter coefficient.

In operation S540, the output unit 360 may store the image encoded in operation S520 and the optimal filter coefficient computed in operation S530, and transmit the stored image and optimal filter coefficient to the scalable video decoding apparatus 400.

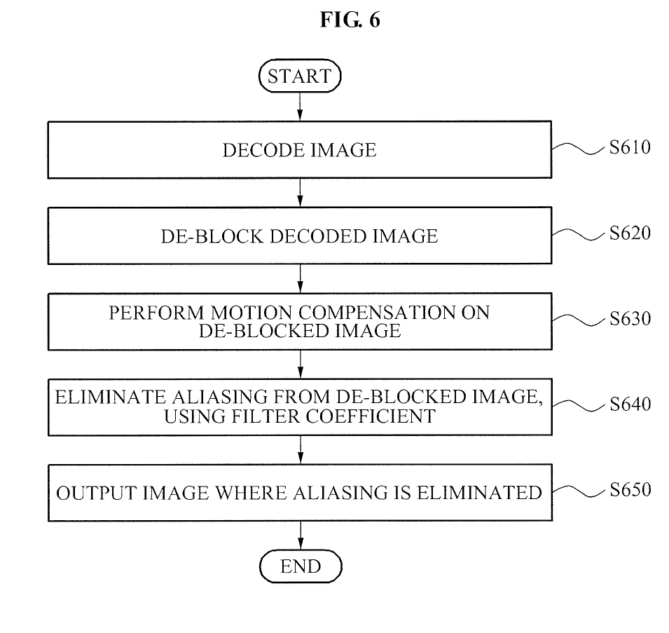

FIG. 6 is a flowchart illustrating a down-sampling method of decoding a scalable video according to other exemplary embodiments.

In operation S610, the entropy decoding unit 120 may decode an image transmitted from the input unit 410, and transmit the decoded image to the de-blocking filter 460.

In this instance, the scaling unit 430 may scale the image decoded by the entropy decoding unit 420 to transmit the scaled image to the de-blocking filter 460. The enhancement layer verification unit 440 may estimate an inter-layer when an enhancement layer is included in the image scaled by the scaling unit 430, and transmit the estimated inter-layer to the de-blocking filter 460.

Also, the combining unit 450 may add the image, where the motion compensation scheme is applied by the motion compensation unit 470, to an image outputted from the entropy decoding unit 420, the scaling unit 430, or the enhancement layer verification unit 440, and transmit the added images to the de-blocking filter 460.

In operation S620, the de-blocking filter 460 may apply a de-blocking filtering to the image decoded in operation S610 to thereby reduce a block distortion.

In this instance, the de-blocking filter 460 may apply the de-blocking filtering to the image where the motion compensation scheme is applied by the motion compensation unit 470, based on the inter-layer estimated by the enhancement layer verification unit 440, to thereby reduce the block distortion.

In operation S630, the motion compensation unit 470 may apply the motion compensation scheme to the image de-blocked in operation S620, and transmit, to the de-blocking filter 460, the image where the motion compensation scheme is applied, through the combining unit 450.

In operation S640, the aliasing elimination unit 480 may eliminate aliasing from the image de-blocked in operation S620, using an optimal filter coefficient.

In operation S650, the aliasing elimination unit 480 may output an image where the aliasing is eliminated in operation S640.

As described above, the scalable video decoding apparatus according to exemplary embodiments may process an image, which is de-blocked using a de-blocking filter, utilizing a motion compensation scheme, a half-pel filter, and a quarter-pel filter in the stated order to thereby output the processed image, without directly outputting the de-blocked image, whereby an image quality of a base layer may be improved without an increase in an amount of computation and without using an anti-aliasing filter.

Also, as for the scalable video encoding/decoding apparatus according to exemplary embodiments, when the scalable video encoding apparatus computes an optimal filter coefficient based on an encoded image and a reference image and transmits the computed optimal filter coefficient together with the encoded image to the scalable video decoding apparatus, the scalable video decoding apparatus may eliminate aliasing using the received optimal filter coefficient, whereby an image quality of a base layer may be improved without using the anti-aliasing filter.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A scalable video decoding apparatus, comprising:
an entropy decoding unit to decode an image received from an encoding apparatus;
a de-blocking filter to reduce a block distortion of the decoded image;
a motion compensation unit to apply a motion compensation scheme to an image passing through the de-blocking filter;
a half-pel filter to apply a half-pel compensation scheme to an image where the motion compensation scheme is applied by the motion compensation unit; and
an output unit to output an image where the half-pel compensation scheme is applied by the half-pel filter.

2. The scalable video decoding apparatus of claim 1, further comprising:
a quarter-pel filter to apply a quarter-pel compensation scheme to an image where the half-pel compensation scheme is applied using the half-pel filter, wherein
the output unit selects one of the image where the quarter-pel compensation scheme is applied and the image where the half-pel compensation scheme is applied, in accordance with an input or a predetermined condition, and outputs the selected image.

3. The scalable video decoding apparatus of claim 2, wherein the output unit adjusts a size of the outputted image by applying pixel decimation to the selected image.

4. The scalable video decoding apparatus of claim 2, further comprising:
a scaling unit to convert a size of the image decoded in the entropy decoding unit; and
an enhancement layer verification unit to estimate an inter-layer when the image converted in the scaling unit includes an enhancement layer, wherein
the de-blocking filter reduces a block distortion of an image outputted in the enhancement layer verification unit.

5. A scalable video encoding apparatus, comprising:
an encoding unit to encode an image inputted by a user;
an anti-aliasing filter computation unit to compute an optimal filter coefficient based on the image encoded in the encoding unit and a reference image; and
an output unit to store and transmit the encoded image and the optimal filter coefficient.

6. The scalable video encoding apparatus of claim 5, wherein the image inputted in the encoding unit is an image where a reference anti-aliasing filtering is applied using a reference anti-aliasing filter.

7. The scalable video encoding apparatus of claim 5, wherein the image inputted in the encoding unit is an image where anti-aliasing is not considered, or an image where a down-sampling is applied to reduce the anti-aliasing.

8. The scalable video encoding apparatus of claim 5, wherein the reference image is an image where a down-sampling is applied by a reference down-sampling unit.

9. The scalable video encoding apparatus of claim 5, wherein the anti-aliasing filter computation unit applies a two-dimensional filter to the encoded image and the reference image to compute the optimal filter coefficient.

10. The scalable video encoding apparatus of claim 5, wherein the anti-aliasing filter computation unit applies a one-dimensional filter to the encoded image and the reference image to compute the optimal filter coefficient.

11. A scalable video decoding apparatus, comprising:
an input unit to receive, from an encoding apparatus, an encoded image and an optimal filter coefficient;
an entropy decoding unit to decode the encoded image;
a de-blocking filter to reduce a block distortion of the decoded image;
a motion compensation unit to apply a motion compensation scheme to an image passing through the de-blocking filter; and
an aliasing elimination unit to eliminate an aliasing from the image passing through the de-blocking filter using the optimal filter coefficient, and to output an image where the aliasing is eliminated.

12. The scalable video decoding apparatus of claim 11, wherein the de-blocking filter de-blocks the decoded image and an image where the motion compensation scheme is applied by the motion compensation unit to reduce the block distortion.

13. A down-sampling method for decoding a scalable video, the down-sampling method comprising:
decoding an image received from an encoding apparatus;
reducing a block distortion by de-blocking the decoded image;
applying a motion compensation scheme to the de-blocked image;
applying a half-pel compensation scheme to an image where the motion compensation scheme is applied; and
outputting an image where the half-pel compensation scheme is applied.

14. The down-sampling method of claim 13, further comprising:
applying a quarter-pel compensation scheme to an image where the half-pel compensation scheme is applied, wherein
the outputting selects one of an image where the quarter-pel compensation scheme is applied and the image where the half-pel compensation scheme is applied, in accordance with an input or a predetermined condition, and outputs the selected image.

15. A scalable video encoding method, comprising:
encoding an inputted image;
computing an optimal filter coefficient based on the encoded image and a reference image; and
storing and transmitting the encoded image and the optimal filter coefficient.

16. The scalable video encoding method of claim 15, wherein the encoded image is an image where a reference anti-aliasing filtering is applied.

17. The scalable video encoding method of claim 15, wherein the encoded image is an image where anti-aliasing is not considered, or an image where a down-sampling is applied to reduce the anti-aliasing.

18. The scalable video encoding method of claim 15, wherein the computing applies a two-dimensional filter to the encoded image and the reference image to compute the optimal filter coefficient.

19. The scalable video encoding method of claim 15, wherein the computing applies a one-dimensional filter to the encoded image and the reference image to compute the optimal filter coefficient.

20. A down-sampling method for decoding a scalable video, the down-sampling method comprising:
receiving, from an encoding apparatus, an encoded image and an optimal filter coefficient;
decoding the encoded image;
reducing a block distortion by de-blocking the decoded image;
applying a motion compensation scheme to the de-blocked image;
eliminating an aliasing from the de-blocking image using the optimal filter coefficient; and
outputting an image where the aliasing is eliminated, wherein
the reducing de-blocks the decoded image and an image where the motion compensation scheme is applied to reduce the block distortion.
